(19) United States
(12) Patent Application Publication
(10) Pub. No.: US 2013/0002625 A1
(43) Pub. Date: Jan. 3, 2013

(54) PIXEL STRUCTURE AND METHOD OF DRIVING THE SAME

(75) Inventors: Pei-Chun Liao, Changhua County (TW); Wen-Hao Hsu, Hsinchu County (TW); Hui-Jun Wang, Hsinchu City (TW)

(73) Assignee: AU OPTRONICS CORPORATION, Hsinchu (TW)

(21) Appl. No.: 13/287,114

(22) Filed: Nov. 1, 2011

(30) Foreign Application Priority Data
Jun. 29, 2011 (TW) 100122906

(51) Int. Cl. G06F 3/038; G09G 3/36

(52) U.S. Cl. 345/205; 345/87

(57) ABSTRACT

A pixel structure includes a scan line, a data line, a driving device, a first pixel electrode, an insulating layer and a second pixel electrode. The driving device is electrically connected to the scan line and the data line. The first pixel electrode is electrically connected to the driving device. The insulating layer covers the first pixel electrode. The second pixel electrode is disposed on the insulating layer. The second pixel electrode is electrically connected to the driving device and is not directly connected to or not contacted with the first pixel electrode.

### CROSS-REFERENCE TO RELATED APPLICATION

This application claims the priority benefit of Taiwan application serial no. 100122906, filed on Jun. 29, 2011. The entirety of the above-mentioned patent application is hereby incorporated by reference herein and made a part of this specification.

### BACKGROUND OF THE INVENTION

1. Field of the Invention

The present invention relates to a pixel structure and a method of driving the same, and more particularly, the present invention relates to a pixel structure and a method of driving the same capable of reduce color washout of a display device.

2. Description of Related Art

At present, some of the basic demands on the LCD include properties such as a high contrast ratio, rapid response and wide viewing angle. The technologies capable of providing a wide viewing angle include, for example, multi-domain vertical alignment (MVA), multi-domain horizontal alignment (MHA), twisted nematic plus wide viewing film (TN+film) and in-plane switching (IPS). Although the LCD adopting the above-mentioned technologies can achieve the purpose of the wide viewing angle, but the color washout phenomenon is denounced by users.

In general, the color washout phenomenon means that user would watch an image frame with different color tones when user watches the image frame displayed on the LCD by different viewing angles. For example, if user stands at an oblique viewing angle such as 60 degree to view the image frame displayed on the LCD, the color tone of the image frame watched by user is whiter than the color tone of the image frame watched by user standing at a direct viewing angle such as 90 degree.

In order to resolve the color washout phenomenon, a conventional method is provided, in which the pixel electrode in one pixel structure is divided into at least one main pixel electrode and at least one sub-pixel electrode, and the main pixel electrode and the sub-pixel electrode are applied with different voltages. However, the aperture ratio of the pixel structure is reduced because a spacing region should be formed in the pixel electrode to separate the main pixel electrode and the sub-pixel electrode. Because liquid crystal molecules above the spacing region can not be driven to twist, the aperture ratio of the pixel structure is reduced.

### SUMMARY OF THE INVENTION

Accordingly, the present invention is directed to a pixel structure and a method of driving the same capable of resolving the reduction of the aperture ratio of the pixel structure owing to the spacing region is formed in the pixel electrode to separate the main pixel electrode and the sub-pixel electrode.

The present invention provides a pixel structure which includes a scan line, a data line, a driving device, a first pixel electrode, an insulating layer and a second pixel electrode. The driving device is electrically connected to the scan line and the data line. The first pixel electrode is electrically connected to the driving device. The insulating layer covers the first pixel electrode. The second pixel electrode is disposed on the insulating layer. The second pixel electrode is electrically connected to the driving device and is not directly connected to or not contacted with the first pixel electrode.

The present invention provides a pixel structure which includes a scan line, a data line, a driving device, a first pixel electrode, an insulating layer and a second pixel electrode. The driving device is electrically connected to the scan line and the data line. The first pixel electrode is electrically connected to the driving device and has a first area (A1). The insulating layer covers the first pixel electrode. The second pixel electrode is disposed on the insulating layer and electrically connected to the driving device. The second pixel electrode has a second area (A2), an overlapping region between the first pixel electrode and the second pixel electrode has an overlapping area (A0), and A0/(A1+A2−A0)=0%-15%.

The present invention provides a pixel structure which includes a first scan line, a second scan line, a sharing switch device electrically connected to the second scan line, a data line, a driving device, a first pixel electrode, an insulating layer and a second pixel electrode. The sharing switch device is electrically connected to the first pixel electrode or the second pixel electrode. The driving device is electrically connected to the first scan line and the data line. The first pixel electrode is electrically connected to the driving device. The insulating layer covers the first pixel electrode. The second pixel electrode is disposed on the insulating layer. The second pixel electrode is electrically connected to the driving device and is not directly connected to or not contacted with the first pixel electrode.

The present invention provides a method of driving a pixel structure. A pixel structure as above mentioned is provided. A first scan signal is input to the first scan line and a data signal is input to the first data line in a first time period. A second scan signal is input to the second scan line and the data signal is input to the first data line in a second time period. In particular, the first pixel electrode has a first voltage and the second pixel electrode has a second voltage different from the first voltage during the second time period.

In light of the foregoing, the first pixel electrode and the second pixel electrode are disposed in different film layers and are separated from each other by the insulating layer. Therefore, a spacing region for separating the main pixel electrode and the sub-pixel electrode is not required in the pixel structure of the present invention, and the aperture ratio of the pixel structure can be improved. In addition, in an embodiment of the present invention, the first pixel electrode and the second pixel electrode have different voltages though disposing the sharing switch device in the pixel structure, so as to reduce the color washout phenomenon of the display device.

In order to make the aforementioned and other features and advantages of the present invention more comprehensible, several embodiments accompanied with figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic diagram showing a top view of a pixel structure according to an embodiment of the present invention.

FIG. 2 is cross-sectional diagram along the cross-sectional line I-I′, the cross-sectional line II-II′ and the cross-sectional line in FIG. 1.

FIG. 3 is a schematic circuit diagram of the pixel structure in FIG. 1.

FIG. 4 is a schematic diagram showing a top view of a pixel structure according to an embodiment of the present invention.

FIG. 5 is schematic cross-sectional diagram along the cross-sectional line I-I′, the cross-sectional line II-II′ and the cross-sectional line in FIG. 4.

FIG. 6-FIG. 15 are schematic diagrams showing a top view of a pixel structure according to embodiments of the present invention.

FIG. 16 is a schematic diagram showing a method of driving a pixel structure according to an embodiment of the present invention.

FIG. 17-FIG. 19 are schematic diagrams showing a top view of a pixel structure according to embodiments of the present invention.

FIG. 20 is a schematic cross-sectional diagram showing a display panel according to an embodiment of the present invention.

### DESCRIPTION OF EMBODIMENTS

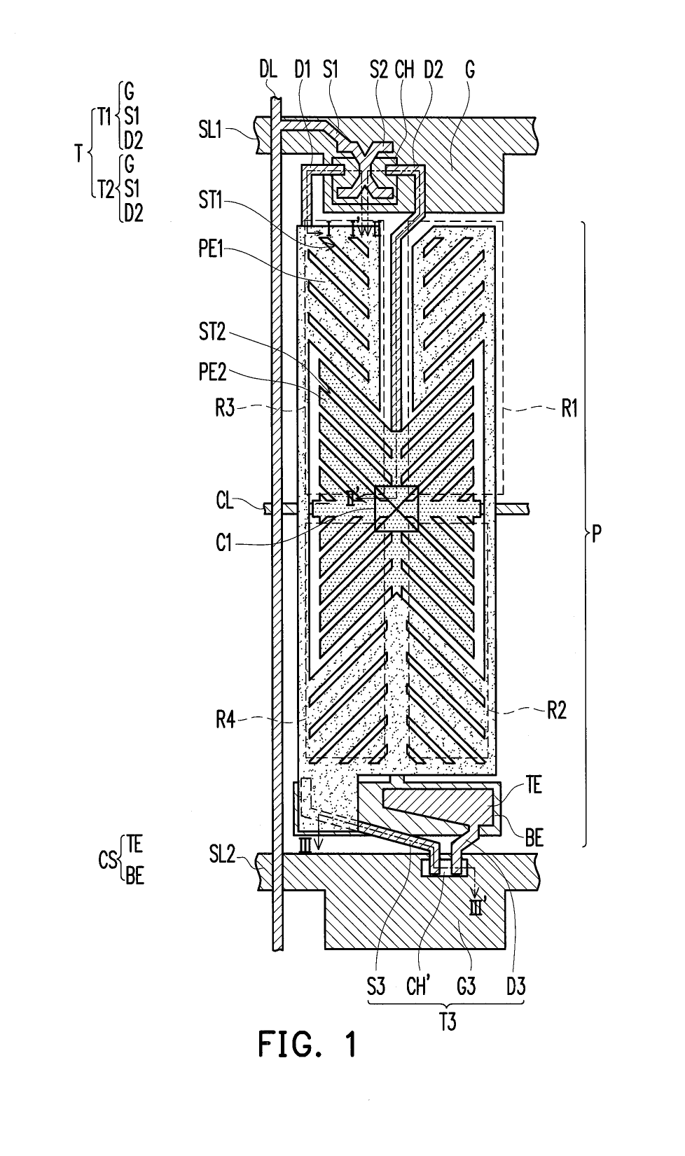

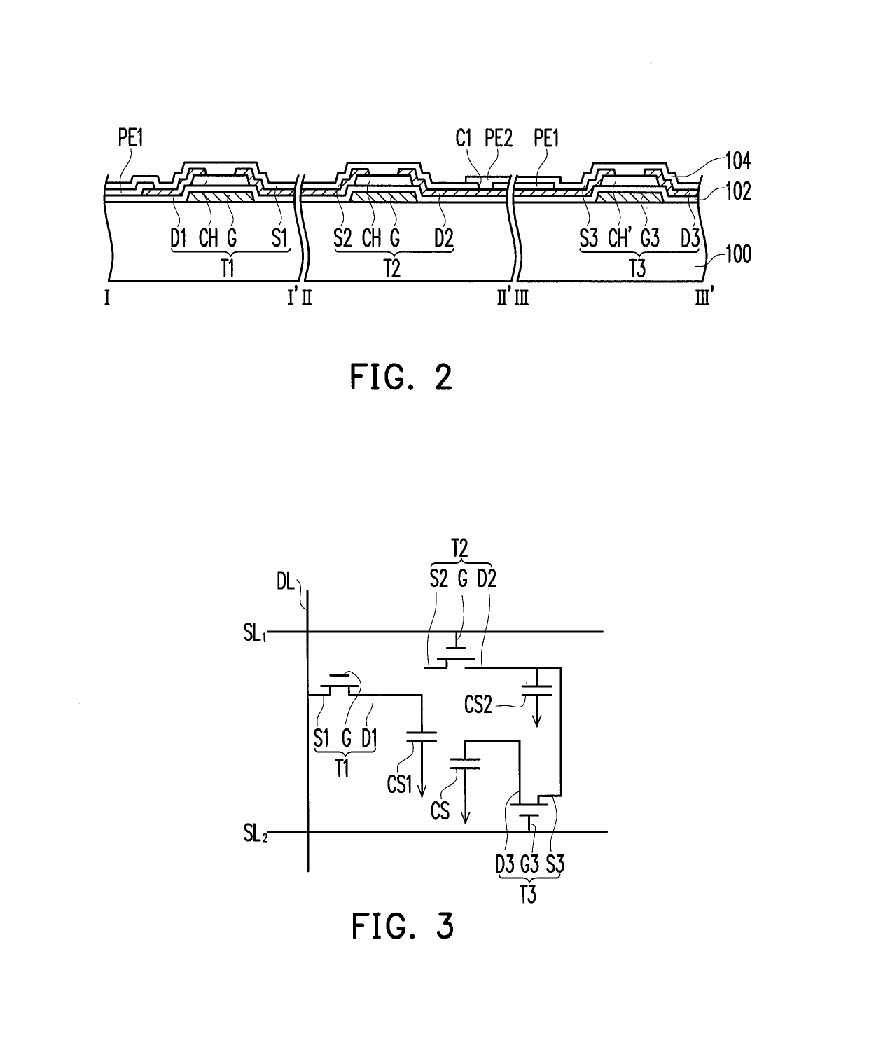

FIG. 1 is a schematic diagram showing a top view of a pixel structure according to an embodiment of the present invention. FIG. 2 is cross-sectional diagram along the cross-sectional line I-I′, the cross-sectional line II-II′ and the cross-sectional line in FIG. 1. FIG. 3 is a schematic circuit diagram of the pixel structure in FIG. 1. Referring to FIG. 1, FIG. 2 and FIG. 3, the pixel structure is disposed on a substrate 100 and comprises a first scan line SL1, a second scan line SL2, a data line DL, a driving device T, a first pixel electrode PE1, an insulating layer 104, a second pixel electrode PE2 and a sharing switch device T3.

The substrate 100 can be made of glass, quartz, an organic polymer, an opaque/reflective material (such as a conductive material, metal, wafer, ceramics, or any other appropriate material), or any other appropriate material.

The first scan line SL1, the second scan line SL2 and the data line DL are located on the substrate 100. In this embodiment, the first scan line SL1 and the second scan line SL2 cross over the data line DL, and an insulation layer 102 is sandwiched between the first scan line SL1 (the second scan line SL2) and the data line DL. That is to say, an extension direction of the data line DL is not parallel to extension directions of the first scan line SL1 and the second scan line SL2. Preferably, the extension direction of the data line DL is perpendicular to the extension directions of the first scan line SL1 and the second scan line SL2. In consideration of electrical conductivity, the data line DL, the first scan line SL1 and the second scan line SL2 are often made of metal materials. However, the invention is not limited thereto. According to other embodiments of the invention, the data line DL, the first scan line SL1 and the second scan line SL2 can also be made of other conductive materials. The metal material includes, for example, an alloy, metal nitride, metal oxide, metal oxynitride, another appropriate material, or a layer in which the metal material and any other conductive material are stacked to each other.

The driving device T is electrically connected the first scan line SL1 and the data line DL. According to the embodiment, the driving device T comprises a first active device T1 and a second active device T2. The first active device T1 is electrically connected to the first scan line SL1 and the data line DL, and the second active device T2 is also electrically connected to the first scan line SL1 and the data line DL. For detail, the first active device T1 comprises a gate G, a channel CH, a source S1 and a drain D1. The gate G is electrically connected to the first scan line SL1, the insulating layer 102 covers the gate G and a common electrode line CL, the channel CH is disposed above the gate G, the source Si and the drain D1 are disposed on the channel CH, and the source S1 is electrically connected to the data line DL. The second active device T2 comprises the gate G, the channel CH, a source S2 and a drain D2. The gate G is electrically connected to the first scan line SL1, the insulating layer 102 covers the gate G and the first scan line SL1, the channel CH is disposed above the gate G, the source S2 and the drain D2 are disposed on the channel CH, and the source S2 is also electrically connected to the data line DL. In the embodiment, the first active device T1 and the second active device T2 have the common gate G and the common channel CH. The first active device T1 and the second active device T2 are bottom gate thin film transistors, which are taken as an example for descriptions. According to another embodiment, the first active device T1 and the second active device T2 may also be top gate thin film transistors.

The first pixel electrode PE1 is electrically connected to the driving device T. In the embodiment, the first pixel electrode PE1 is electrically connected to the first active device T1 of the driving device T. For detail, the first pixel electrode PEI is directly connected to the drain D1 of the first active device T1, as shown in FIG. 2. Namely, the first pixel electrode PE1 is disposed on the insulating layer 102 and directly contacts with the drain D1 of the first active device T1. In the embodiment, the first pixel electrode PE1 is a transparent pixel electrode, a reflective pixel electrode or a transflective pixel electrode. The transparent pixel electrode comprises a metal oxide, such as indium tin oxide (ITO), indium zinc oxide (IZO), aluminum tin oxide (ATO), aluminum zinc oxide (AZO), indium-gallium-zinc oxide (IGZO) or any other suitable metal oxide material, or at least two of materials above stacked to each other. The reflective pixel electrode comprises a metal material having high reflectivity.

The insulating layer 104 is disposed on the substrate 100 and covers the first pixel electrode PE1. The insulating layer 104 can be made of an inorganic material (such as silicon oxide, silicon nitride, or silicon oxynitride), an organic material or a stacked layer containing the insulating material and any other insulating material. The insulating layer 104 has a contact window C1 therein, and the contact window C1 is electrically connected to the second active device T2 of the driving device T. For detail, the contact window C1 is electrically connected to the drain D2 of the second active device T2.

It is noted that in the embodiment the contact window C1 is disposed in a central position of the pixel structure, and it does not limited in the invention. According to another embodiment, the contact window C1 may be disposed in other positions of the pixel structure as long as the contact window C1 can be electrically connected to the drain D2 of the second active device T2.

The second pixel electrode PE2 is disposed on the insulating layer 104, as shown in FIG. 2. The second pixel electrode PE2 is electrically connected to the driving device T through the contact window C1. For detail, the second pixel electrode PE2 is disposed on the insulating layer 104 and is electrically connected to the drain D2 of the second active device T2 through the contact window C1 in the insulating layer 104. In the embodiment, the second pixel electrode PE2 is a transparent pixel electrode, a reflective pixel electrode or a transflective pixel electrode. The transparent pixel electrode comprises a metal oxide, such as indium tin oxide (ITO), indium zinc oxide (IZO), aluminum tin oxide (ATO), aluminum zinc oxide (AZO), indium-gallium-zinc oxide (IGZO) or any other suitable metal oxide material, or at least two of materials above stacked to each other. The reflective pixel electrode comprises a metal material having high reflectivity.

According to the embodiment, the first pixel electrode PE1 and the second pixel electrode PE2 are separated from each other by the insulating layer 104, such that the second pixel electrode PE2 is not directly connected to or not contacted with the first pixel electrode PE1. Hence, the second pixel electrode PE2 is electrically connected to the first pixel electrode PE1 indirectly. In addition, the first pixel electrode PE1 may partially overlap with the second pixel electrode PE2 or does not overlap with the second pixel electrode PE2. For instance, the first pixel electrode PE1 has a first area (A1), the second pixel electrode PE2 has a second area (A2), and an overlapping region between the first pixel electrode PE1 and the second pixel electrode PE2 has an overlapping area (A0), wherein A0/(A1+A2−A0)=0%-15%. Therefore, most of the first pixel electrode PE1 and the second pixel electrode PE2 do not overlap to each other, and only small parts of the first pixel electrode PE1 and the second pixel electrode PE2 overlap to each other. In an embodiment, the first pixel electrode PE1 and the second pixel electrode PE2 do not overlap to each other, and the edge of the first pixel electrode PE1 are align to the edge of the second pixel electrode PE2. In another embodiment, the first pixel electrode PE1 and the second pixel electrode PE2 do not overlap to each other, and a space is between the edge of the first pixel electrode PE1 and the edge of the second pixel electrode PE2.

The sharing switch device T3 is electrically connected to the second scan line SL2. The sharing switch device T3 comprises a gate G3, a channel CH′, a source S3 and a drain D3. The gate G3 is electrically connected to the second scan line SL2, the insulating layer 102 covers the gate G3 and the second scan line SL2, the channel CH′ is disposed above the gate G3, and the source S3 and the drain D3 are disposed on the channel CH′. In the embodiment, the sharing switch device T3 is a bottom gate thin film transistor which is taken as an example for descriptions. According to another embodiment, the sharing switch device T3 may also be a top gate thin film transistor.

According to the embodiment, the sharing switch device T3 is electrically connected to the first pixel electrode PE1. In details, the source S3 of the sharing switch device T3 directly contacts with the first pixel electrode PE1, as shown in FIG. 2.

In the pixel structure of the embodiment, the second pixel electrode PE2 electrically connected to the driving device T is referred as a main pixel electrode, while the first pixel electrode PE1 electrically connected to the sharing switch device T3 and the driving device T is referred as a sub pixel electrode. In the embodiment shown in FIG. 1, the first pixel electrode PE1 (sub pixel electrode) is disposed at two sides of the second pixel electrode PE2 (main pixel electrode). Namely, the second pixel electrode PE2 (main pixel electrode) is disposed inside or in the middle of the first pixel electrode PE1 (sub pixel electrode), which is not limited in the invention. According to another embodiment, the second pixel electrode PE2 (main pixel electrode) may also be disposed outside the first pixel electrode PE1 (sub pixel electrode).

In addition, the pixel structure of the embodiment further comprises a common electrode line CL disposed under the first pixel electrode PE and the second pixel electrode PE2. As shown in FIG. 1, the common electrode line CL in the pixel structure has a cross shape, which is not limited in the invention. The common electrode line CL is electrically connected to a common voltage (Vcom). A first storage capacitor CS1 is formed at an overlapping region between the common electrode line CL and the first pixel electrode PE1, and the second storage capacitor CS2 is formed at an overlapping region between the common electrode line CL and the second pixel electrode PE2.

Moreover, the pixel structure of the embodiment further comprises a capacitor CS electrically connected to the sharing switch device T3. The capacitor CS comprises a top electrode TE and a bottom electrode BE. The top electrode TE is electrically connected to the drain D3 of the sharing switch device T3, for example, the top electrode TE directly contacts with the drain D3 of the sharing switch device T3. The bottom electrode BE is electrically connected to the common voltage (Vcom) through the common electrode line CL.

Furthermore, in the embodiment, the first pixel electrode PE1 further comprises first slits ST1, and the second pixel electrode PE2 further comprises second slits ST2, such that the pixel structure has multi-domain alignment regions and the display device having the pixel structures has wide viewing angle function. The patterns and the arrangements for the first slits ST1 and the second slits ST2 can be well known patterns and arrangements, and the present invention does not limit the patterns and the arrangements for the first slits ST1 and the second slits ST2.

According to the embodiment, a pixel region P is defined by the first scan line SL1, the second scan line SL2 and the data line DL, and a plurality of alignment regions R1-R4 are defined in the pixel region P. The first slits ST1 and the second slits ST2 in the same alignment region (any one of R1-R4, for example) are disposed parallel to each other. For example, in the alignment region R1, the first slits ST1 of the first pixel electrode PE1 area parallel to the second slits ST2 of the second pixel electrode PE2, and first slits ST1 and the second slits ST2 extend along a first direction. In the alignment region R2, the first slits ST1 of the first pixel electrode PEI are parallel to the second slits ST2 of the second pixel electrode PE2, and first slits ST1 and the second slits ST2 extend along a second direction. In the alignment region R3, the first slits ST1 of the first pixel electrode PE1 are parallel to the second slits ST2 of the second pixel electrode PE2, and first slits ST1 and the second slits ST2 extend along a third direction. In the alignment region R4, the first slits ST1 of the first pixel electrode PE1 are parallel to the second slits ST2 of the second pixel electrode PE2, and first slits ST1 and the second slits ST2 extend along a fourth direction. The first, second, third and fourth directions are different completely.

The first pixel electrode PE1 and the second pixel electrode PE2 are disposed in different film layers and are separated from each other by the insulating layer 104. Therefore, a spacing region for separating the first pixel electrode PE1 and the second pixel electrode PE2 is not needed, and the aperture ratio of the pixel structure can be improved.

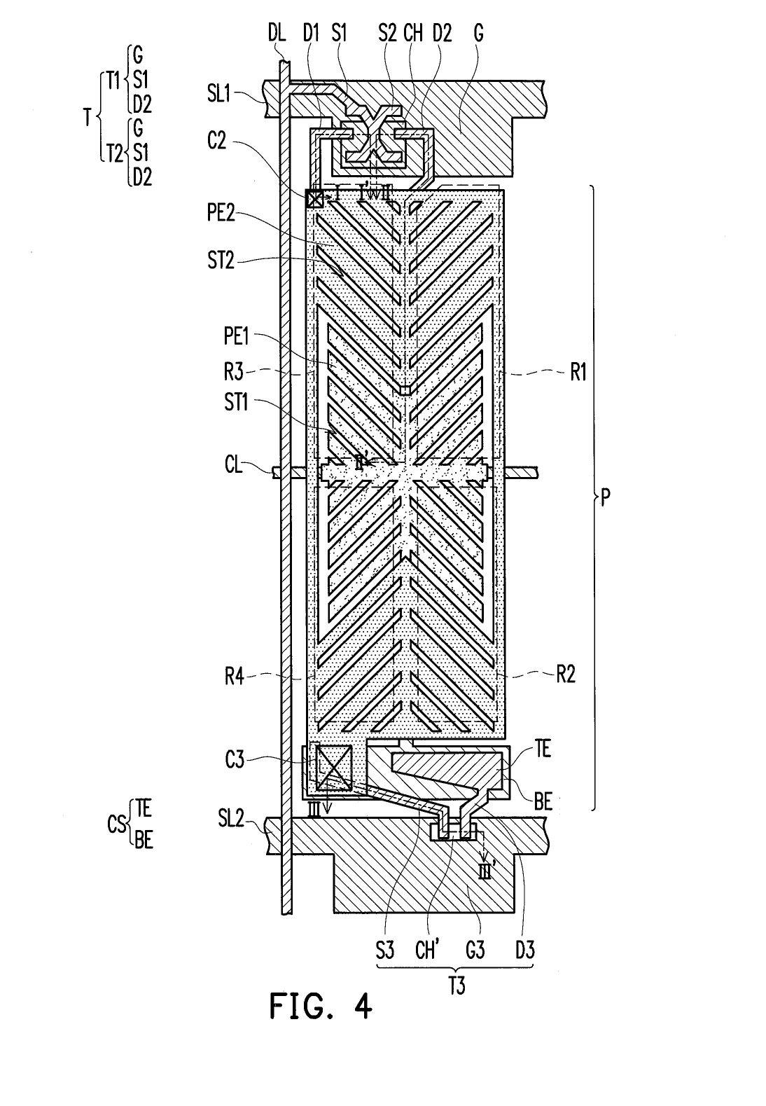

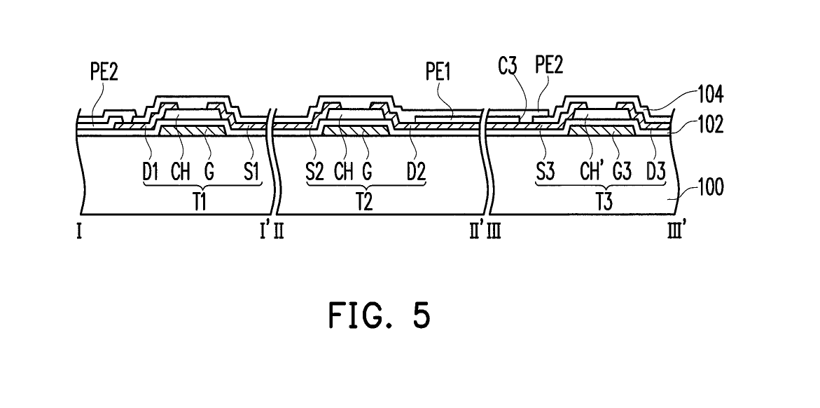

FIG. 4 is a schematic diagram showing a top view of a pixel structure according to an embodiment of the present invention. FIG. 5 is schematic cross-sectional diagram along the cross-sectional line I-I′, the cross-sectional line II-II′ and the cross-sectional line in FIG. 4. With reference to FIG. 4, and FIG. 5, the embodiment is similar to the embodiment depicted in FIG. 1, and the same components indicated in FIG. 1 and FIG. 4 are denoted by the same numerals and are not repeated herein. In the pixel structure of the embodiment, the first pixel electrode PE1 is electrically connected to the second active device T2 of the driving device T, and the second pixel electrode PE2 is electrically connected to the first active device T1 of the driving device T.

For detail, the first pixel electrode PE1 is electrically connected to the drain D2 of the second active device T2. The insulating layer 104 covers the first pixel electrode PE1. The second pixel electrode PE2 is disposed on the insulating layer 104, and the insulating layer 104 has a contact window C2 therein. The second pixel electrode PE2 is electrically connected to the drain Dl of the first active device T1 of the driving device T through the contact window C2 in the insulating layer 104.

The sharing switch device T3 is electrically connected to the second pixel electrode PE2. For detail, the source S3 of the sharing switch device T3 is electrically connected to the second pixel electrode PE2 through a contact window C3 in the insulating layer 104, as shown in FIG. 5. In the embodiment, the first pixel electrode PE1 electrically connected to the driving device T is also referred as a main pixel electrode. The second pixel electrode PE2 electrically connected to the driving device T and the sharing switch device T3 is also referred as a sub pixel electrode. According to the embodiment shown in FIG. 4, the second pixel electrode PE2 (sub pixel electrode) is disposed at least at two sides of the first pixel electrode PE1(main pixel electrode). Namely, the first pixel electrode PE1 (main pixel electrode) is disposed inside or in the middle of the second pixel electrode PE2 (sub pixel electrode).

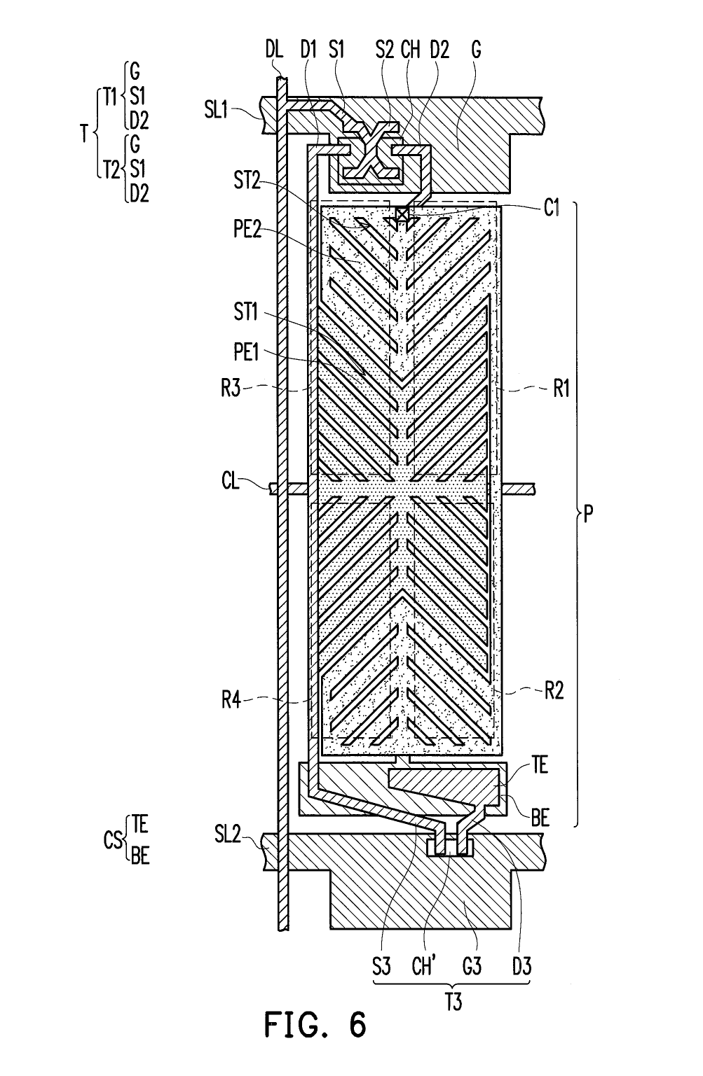

FIG. 6 is a schematic diagram showing a top view of a pixel structure according to an embodiment of the present invention. With reference to FIG. 6, the embodiment is similar to the embodiment depicted in FIG. 1, and the same components indicated in FIG. 1 and FIG. 6 are denoted by the same numerals and are not repeated herein. In the pixel structure of the embodiment, the first pixel electrode PE1 is electrically connected to the first active device T1 of the driving device T, and the second pixel electrode PE2 is electrically connected to the second active device T2 of the driving device T.

For detail, the first pixel electrode PE1 is electrically connected to the drain D1 of the first active device T1 of the driving device T. The insulating layer 104 covers the first pixel electrode PE1. The second pixel electrode PE2 is disposed on the insulating layer 104, and the insulating layer 104 has the contact window C1 therein. The second pixel electrode PE2 is electrically connected to the drain D2 of the second active device T2 of the driving device T through the contact window C1 in the insulating layer 104.

The sharing switch device T3 is electrically connected to the first pixel electrode PE1. For detail, the source S3 of the sharing switch device T3 is directly connected to first pixel electrode PE1. In the embodiment, the second pixel electrode PE2 electrically connected to the driving device T is also referred as a main pixel electrode. The first pixel electrode PE1 electrically connected to the driving device T and the sharing switch device T3 is also referred as a sub pixel electrode. According to the embodiment shown in FIG. 6, the second pixel electrode PE2 (main pixel electrode) is disposed at least at two sides of the first pixel electrode PE1 (sub pixel electrode). Namely, the first pixel electrode PE1 (sub pixel electrode) is disposed inside or in the middle of the second pixel electrode PE2 (main pixel electrode).

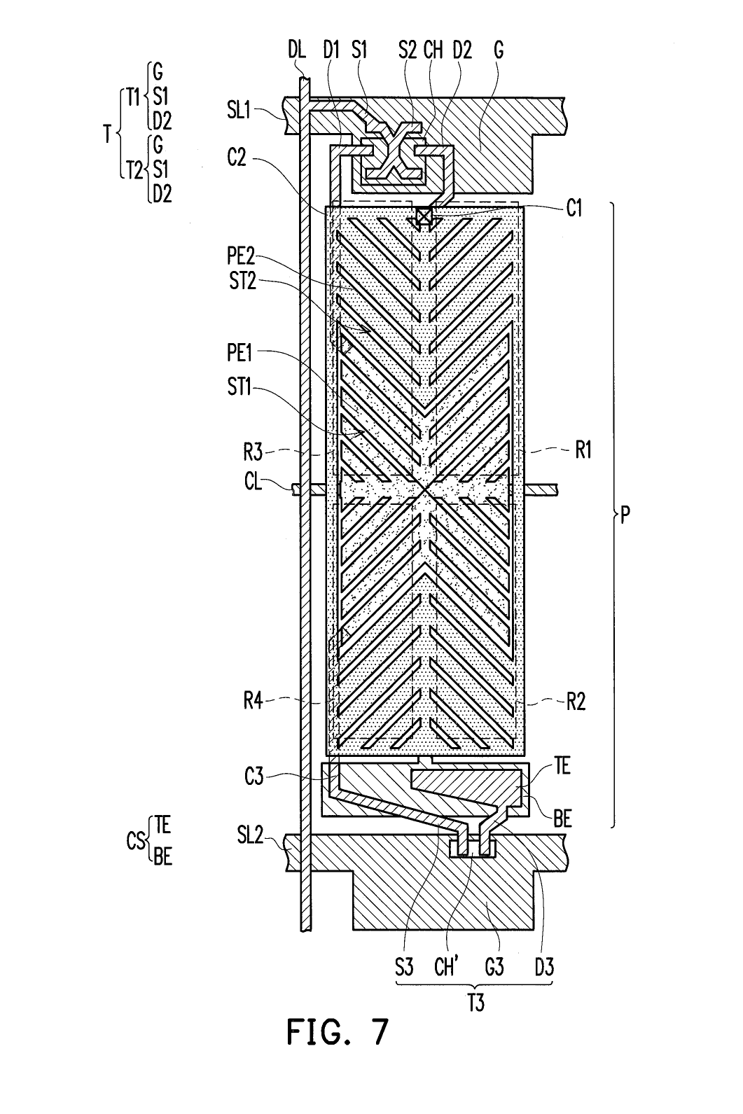

FIG. 7 is a schematic diagram showing a top view of a pixel structure according to an embodiment of the present invention. With reference to FIG. 7, the embodiment is similar to the embodiment depicted in FIG. 1, and the same components indicated in FIG. 1 and FIG. 7 are denoted by the same numerals and are not repeated herein. In the pixel structure of the embodiment, the first pixel electrode PE1 is electrically connected to the first active device T1 of the driving device T, and the second pixel electrode PE2 is electrically connected to the second active device T2 of the driving device T.

For detail, the first pixel electrode PE1 is electrically connected to the drain D1 of the first active device T1 of the driving device T. The insulating layer 104 covers the first pixel electrode PE1. The second pixel electrode PE2 is disposed on the insulating layer 104, and the insulating layer 104 has the contact window C1 therein. The second pixel electrode PE2 is electrically connected to the drain D2 of the second active device T2 of the driving device T through the contact window C1 in the insulating layer 104.

The sharing switch device T3 is electrically connected to the first pixel electrode PEI. For detail, the source S3 of the sharing switch device T3 is directly connected to first pixel electrode PE1. In the embodiment, the second pixel electrode PE2 electrically connected to the driving device T is also referred as a main pixel electrode. The first pixel electrode PE1 electrically connected to the driving device T and the sharing switch device T3 is also referred as a sub pixel electrode. According to the embodiment shown in FIG. 7, the second pixel electrode PE2 (main pixel electrode) is disposed at least at two sides (such as the upper side and the lower side) of the first pixel electrode PE1 (sub pixel electrode). Namely, the first pixel electrode PE1 (sub pixel electrode) is disposed inside or in the middle of the second pixel electrode PE2 (main pixel electrode).

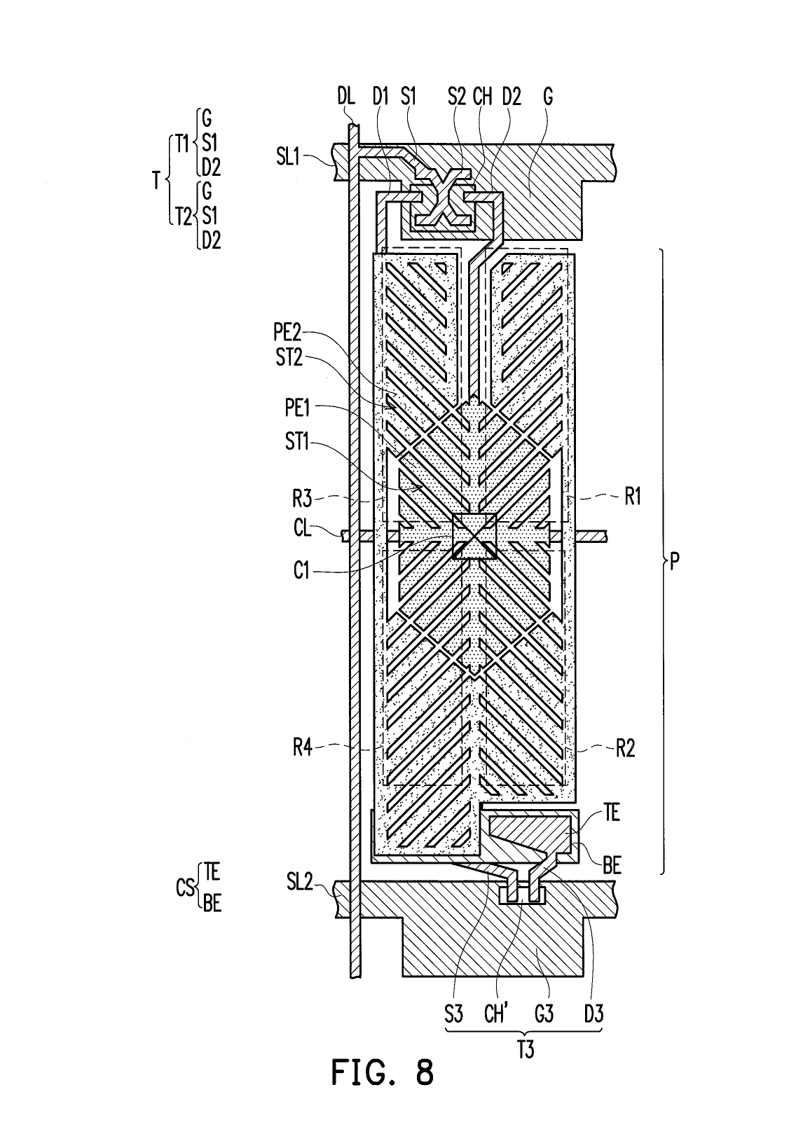

FIG. 8 is a schematic diagram showing a top view of a pixel structure according to an embodiment of the present invention. With reference to FIG. 8, the embodiment is similar to the embodiment depicted in FIG. 1, and the same components indicated in FIG. 1 and FIG. 8 are denoted by the same numerals and are not repeated herein. In the embodiment of FIG. 8, the shape or profile of the second pixel electrode PE2 (main pixel electrode) disposed inside the pixel structure is different from that of the second pixel electrode PE2 shown in FIG. 1. For detail, the shape or profile of the second pixel electrode PE2 (main pixel electrode) in the embodiment of FIG. 1 is a bilateral concave shape or profile however, the shape or profile of the second pixel electrode PE2 (main pixel electrode) in the embodiment of FIG. 8 is a hexagonal shape or profile.

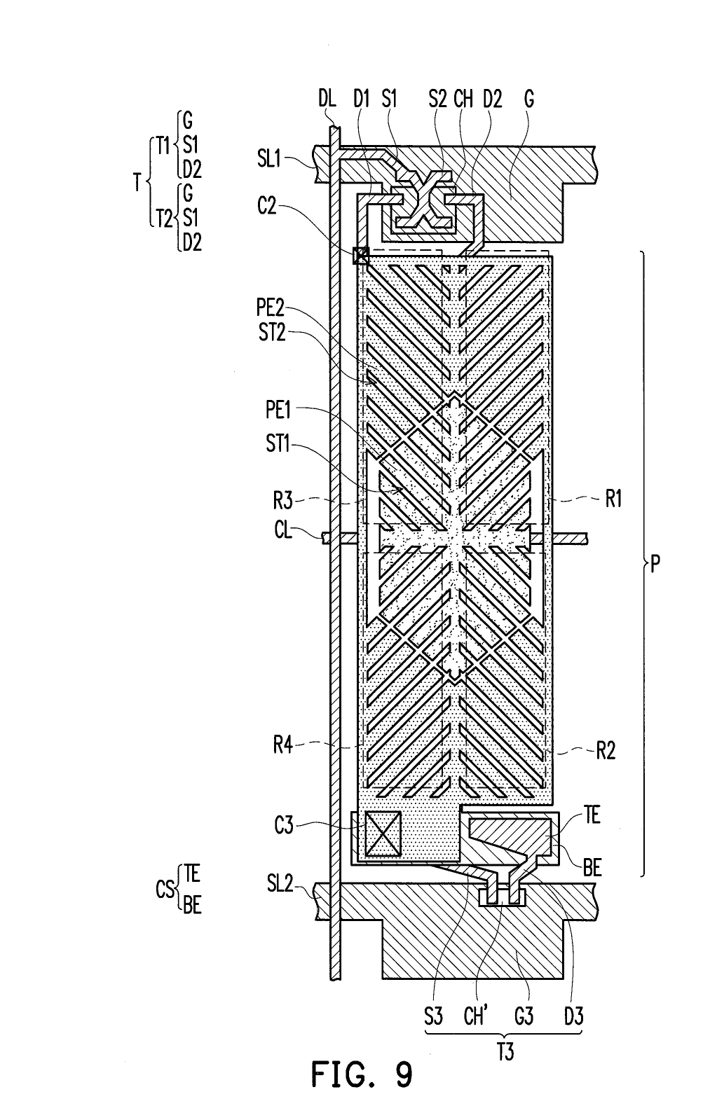

FIG. 9 is a schematic diagram showing a top view of a pixel structure according to an embodiment of the present invention. With reference to FIG. 9, the embodiment is similar to the embodiment depicted in FIG. 4, and the same components indicated in FIG. 4 and FIG. 9 are denoted by the same numerals and are not repeated herein. In the embodiment of FIG. 9, the shape or profile of the first pixel electrode PE1 (main pixel electrode) disposed inside the pixel structure is different from that of the first pixel electrode PE1 shown in FIG. 4. For detail, the shape or profile of the first pixel electrode PE1 (main pixel electrode) in the embodiment of FIG. 4 is a bilateral concave shape or profile, while the shape or profile of the first pixel electrode PE1 (main pixel electrode) in the embodiment of FIG. 9 is a hexagonal shape or profile.

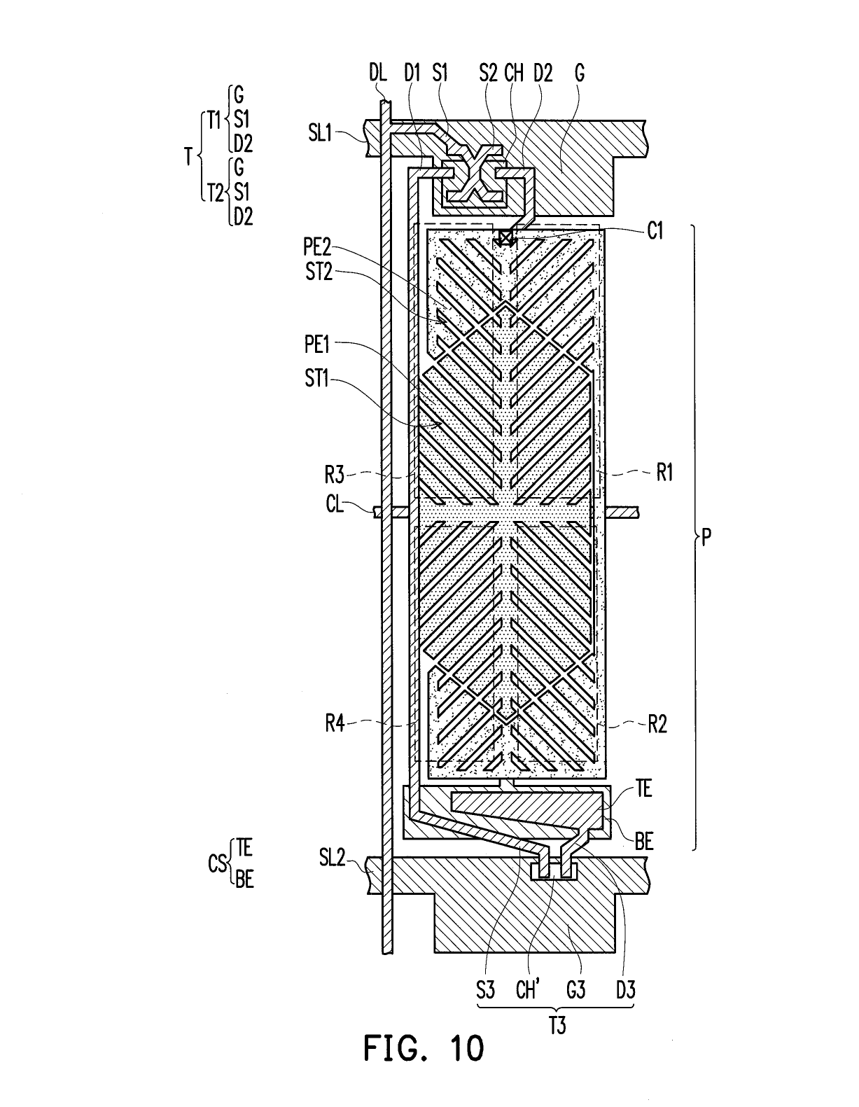

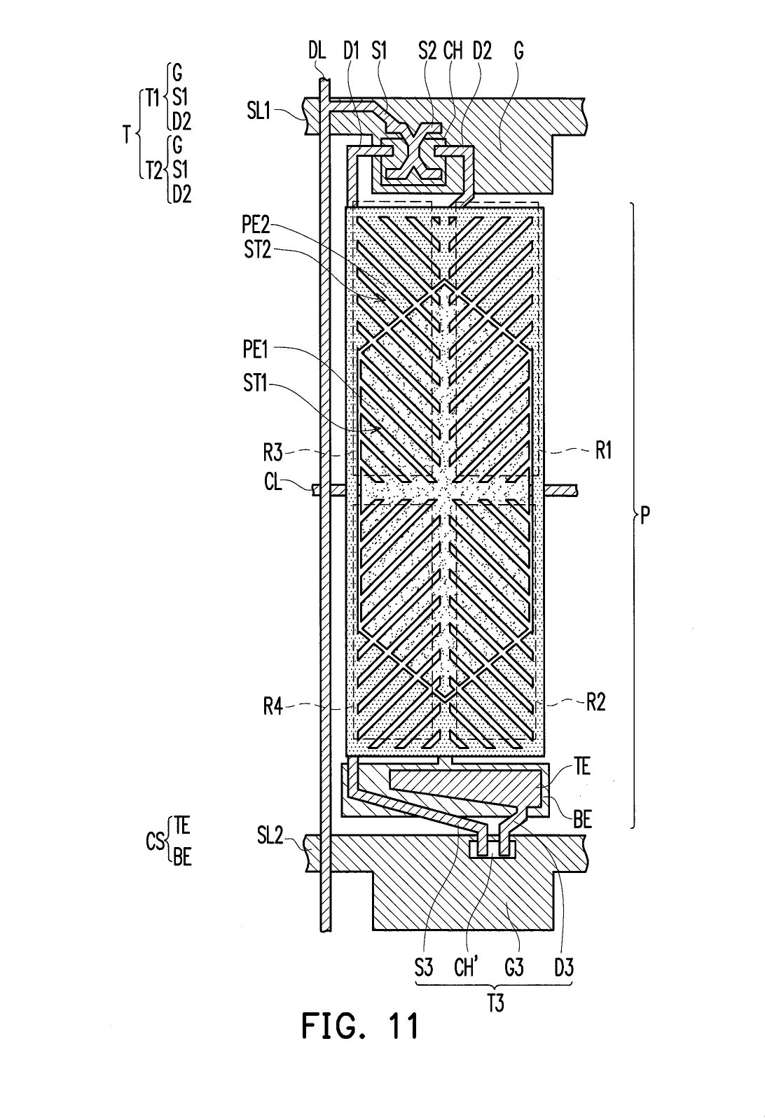

FIG. 10 is a schematic diagram showing a top view of a pixel structure according to an embodiment of the present invention. With reference to FIG. 10, the embodiment is similar to the embodiment depicted in FIG. 6, and the same components indicated in FIG. 6 and FIG. 10 are denoted by the same numerals and are not repeated herein. In the embodiment of FIG. 10, the shape or profile of the first pixel electrode PE1 (sub pixel electrode) disposed inside the pixel structure is different from that of the first pixel electrode PE1 (sub pixel electrode) shown in FIG. 6. For detail, the shape or profile of the first pixel electrode PE1 (sub pixel electrode) in the embodiment of FIG. 6 is a bilateral concave shape or profile however, the shape or profile of the first pixel electrode PE1 (sub pixel electrode) in the embodiment of FIG. 10 is a hexagonal shape or profile.

FIG. 11 is a schematic diagram showing a top view of a pixel structure according to an embodiment of the present invention. With reference to FIG. 11, the embodiment is similar to the embodiment depicted in FIG. 7, and the same components indicated in FIG. 7 and FIG. 11 are denoted by the same numerals and are not repeated herein. In the embodiment of FIG. 11, the shape or profile of the first pixel electrode PE1 (sub pixel electrode) disposed inside the pixel structure is different from that of the first pixel electrode PE1 (sub pixel electrode) shown in FIG. 7. For detail, the shape or profile of the first pixel electrode PE1 (sub pixel electrode) in the embodiment of FIG. 7 is a bilateral concave shape or profile however, the shape or profile of the first pixel electrode PE1 (sub pixel electrode) in the embodiment of FIG. 11 is a hexagonal shape or profile.

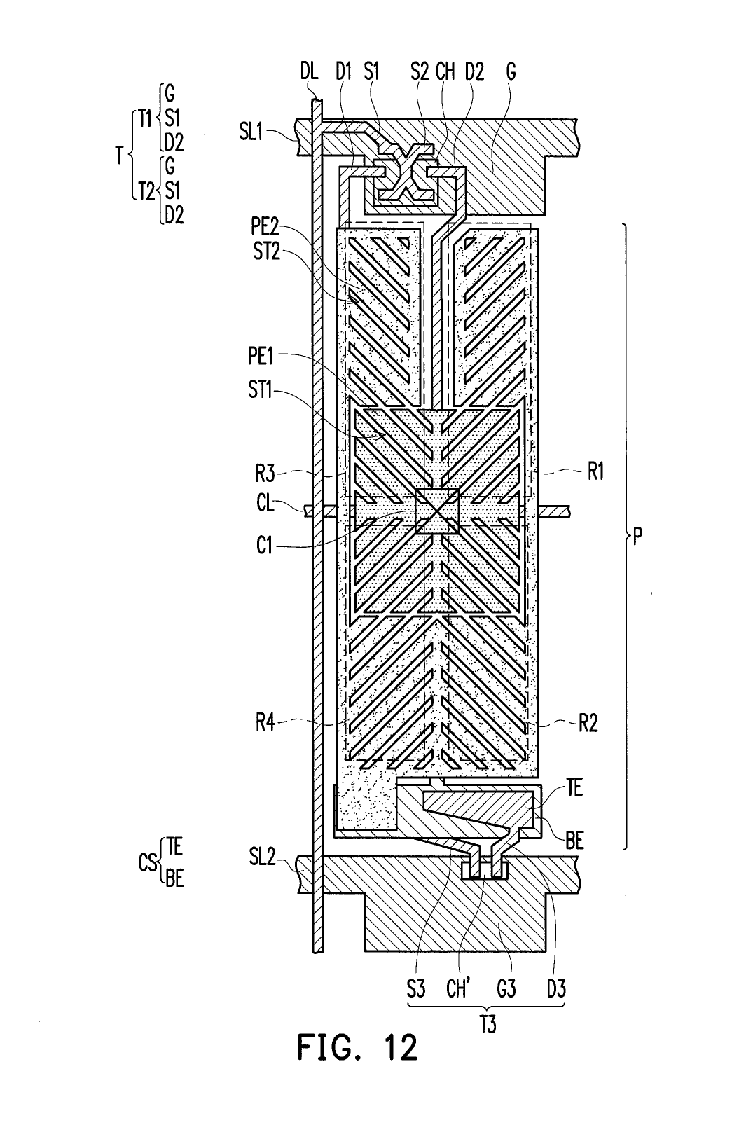

FIG. 12 is a schematic diagram showing a top view of a pixel structure according to an embodiment of the present invention. With reference to FIG. 12, the embodiment is similar to the embodiment depicted in FIG. 1, and the same components indicated in FIG. 1 and FIG. 12 are denoted by the same numerals and are not repeated herein. In the embodiment of FIG. 12, the shape or profile of the second pixel electrode PE2 (main pixel electrode) disposed inside the pixel structure is different from that of the second pixel electrode PE2 shown in FIG. 1. For detail, the shape or profile of the second pixel electrode PE2 (main pixel electrode) in the embodiment of FIG. 1 is a bilateral concave shape or profile however, the shape or profile of the second pixel electrode PE2 (main pixel electrode) in the embodiment of FIG. 12 is a quadrilateral shape or profile.

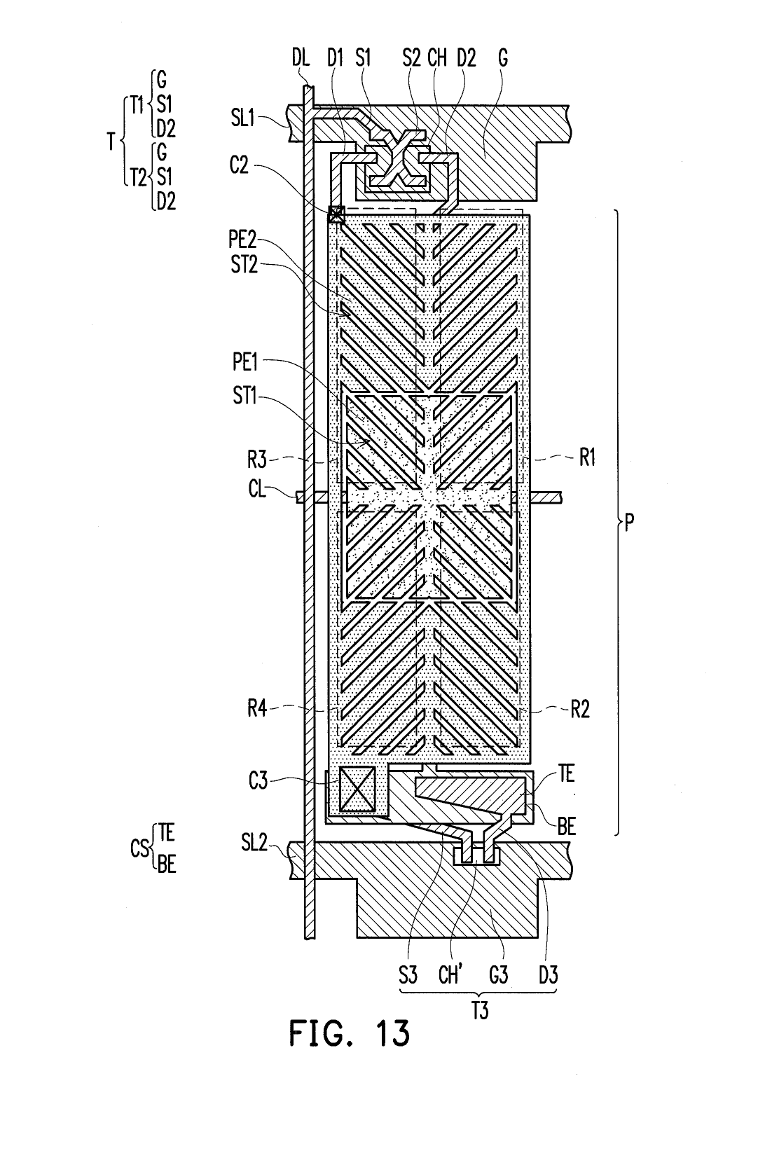

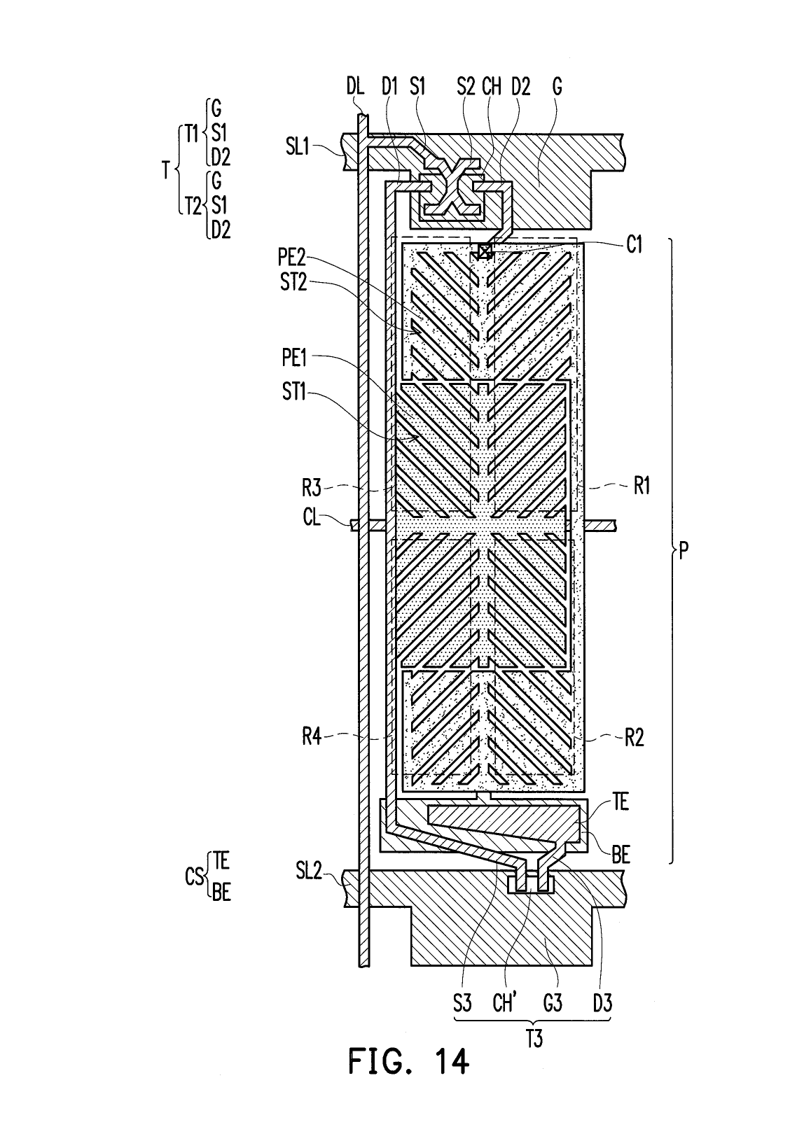

FIG. 13 is a schematic diagram showing a top view of a pixel structure according to an embodiment of the present invention. With reference to FIG. 13, the embodiment is similar to the embodiment depicted in FIG. 4, and the same components indicated in FIG. 4 and FIG. 13 are denoted by the same numerals and are not repeated herein. In the embodiment of FIG. 13, the shape or profile of the first pixel electrode PE1 (main pixel electrode) disposed inside the pixel structure is different from that of the first pixel electrode PE1 shown in FIG. 4. For detail, the shape or profile of the first pixel electrode PE1 (main pixel electrode) in the embodiment of FIG. 4 is a bilateral concave shape or profile however, the shape or profile of the first pixel electrode PE1 (main pixel electrode) in the embodiment of FIG. 13 is a quadrilateral shape or profile.

FIG. 14 is a schematic diagram showing a top view of a pixel structure according to an embodiment of the present invention. With reference to FIG. 14, the embodiment is similar to the embodiment depicted in FIG. 6, and the same components indicated in FIG. 6 and FIG. 14 are denoted by the same numerals and are not repeated herein. In the embodiment of FIG. 14, the shape or profile of the first pixel electrode PE1 (sub pixel electrode) disposed inside the pixel structure is different from that of the first pixel electrode PE1 (sub pixel electrode) shown in FIG. 6. For detail, the shape or profile of the first pixel electrode PE1 (sub pixel electrode) in the embodiment of FIG. 6 is a bilateral concave shape or profile however, the shape or profile of the first pixel electrode PE1 (sub pixel electrode) in the embodiment of FIG. 14 is a quadrilateral shape or profile.

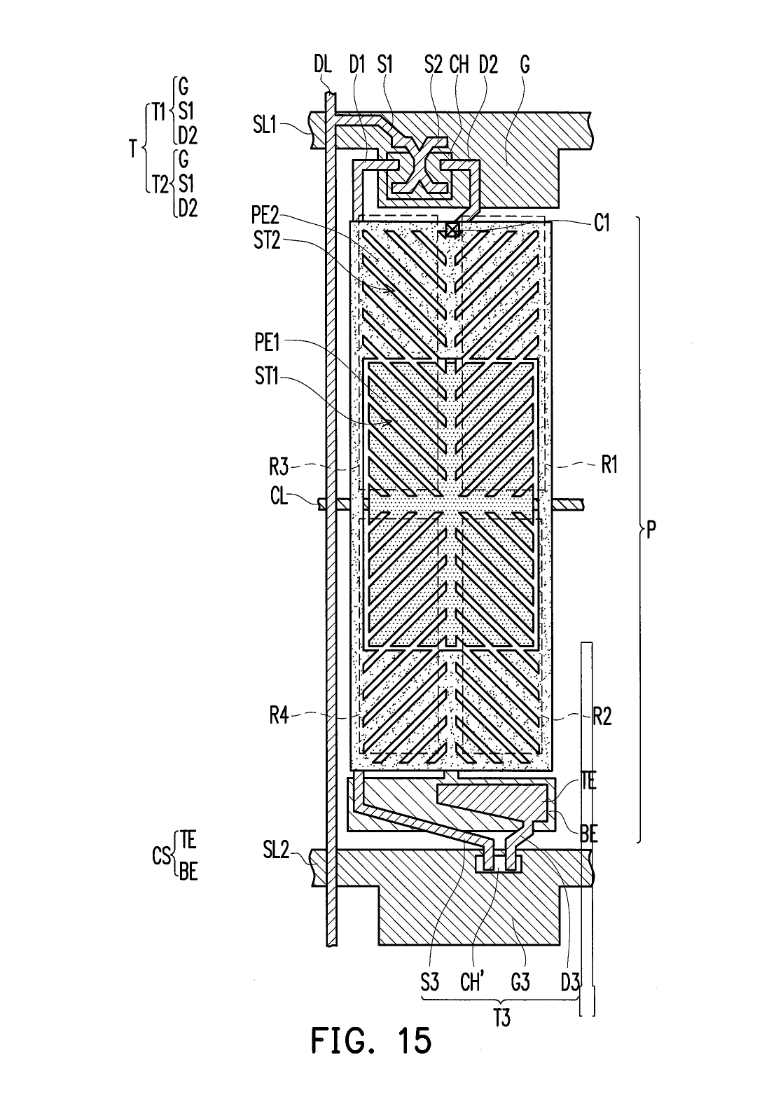

FIG. 15 is a schematic diagram showing a top view of a pixel structure according to an embodiment of the present invention. With reference to FIG. 15, the embodiment is similar to the embodiment depicted in FIG. 7, and the same components indicated in FIG. 7 and FIG. 15 are denoted by the same numerals and are not repeated herein. In the embodiment of FIG. 15, the shape or profile of the first pixel electrode PE1 (sub pixel electrode) disposed inside the pixel structure is different from that of the first pixel electrode PE1 (sub pixel electrode) shown in FIG. 7. For detail, the shape or profile of the first pixel electrode PE1 (sub pixel electrode) in the embodiment of FIG. 7 is a bilateral concave shape or profile however, the shape or profile of the first pixel electrode PE1 (sub pixel electrode) in the embodiment of FIG. 15 is a quadrilateral shape or profile.

In the embodiments as above mentioned, a plurality of combinations of the shapes or profiles for the first pixel electrode PE1 and the second pixel electrode PE2 are taken as examples for descriptions. However, the present invention does not limit the shape or profile for the first pixel electrode PE1 and the second pixel electrode PE2. Namely, the first pixel electrode PE1 and the second pixel electrode PE2 may also have other shapes or profiles in other embodiments, such as a circular, a polygon, or an irregular shape or profile.

The pixel structure described in any one of the above mentioned embodiments can be introduced to a display panel, as shown in FIG. 20. The display panel comprises a lower substrate 1000, an upper substrate 3000 and a display medium 2000 between the two substrates 1000, 3000. The pixel structure shown in any one of FIG. 1-FIG. 15 is disposed on the lower substrate 1000. The upper substrate 3000 has a common electrode layer thereon. The display medium 2000 comprises a liquid crystal medium, an electrophoretic display medium or any other applicable medium.

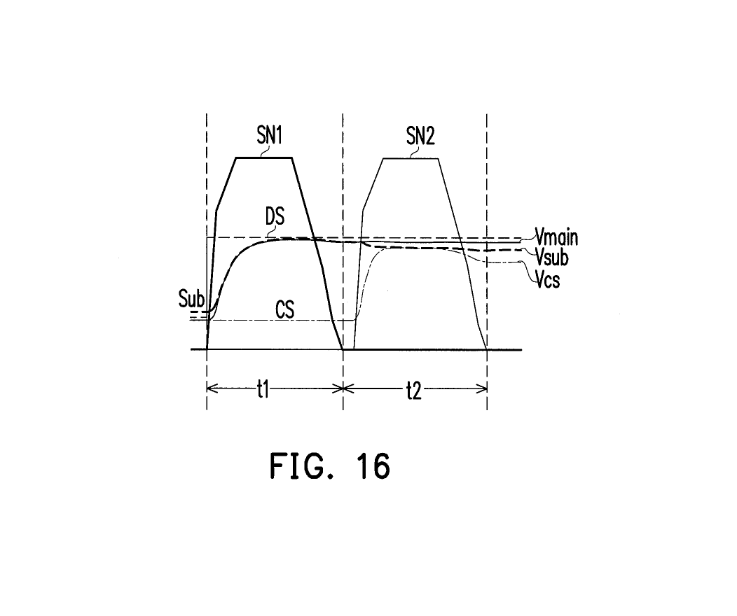

The pixel structure described in the any one of the above mentioned embodiments can be driven by a driving method as following. FIG. 16 is a schematic diagram showing a method of driving a pixel structure according to an embodiment of the present invention. Referring to FIG. 16, the driving method can be used in the pixel structure of any one of FIG. 1-FIG. 15.

The method comprises inputting a first scan signal SN1 to the first scan line SL1 and inputting a data signal DS to the data line DL in a first time period t1. At this time, the first scan line SL1 is input with the first scan signal SN1 and the data line DL is input with the data signal DS, and thereby the main pixel electrode (one of the first pixel electrode PE1 and the second pixel electrode PE2) and the sub pixel electrode (the other one of the first pixel electrode PE1 and the second pixel electrode PE2) are charged simultaneously, such that the main pixel electrode has a voltage Vmain and the sub pixel electrode has a voltage Vsub. During the first time period t1, the voltage Vmain of the main pixel electrode is the same to the voltage Vsub of the sub pixel electrode.

Next, input a second scan signal SN2 to the second scan line SL2 and input the data signal DS to the data line DL in a second time period t2. At this time, the second scan line SL2 is input with the second scan signal SN2 and the data line DL is input with the data signal DS, and thereby the main pixel electrode (one of the first pixel electrode PE1 and the second pixel electrode PE2) and the sub pixel electrode (the other one of the first pixel electrode PE1 and the second pixel electrode PE2) are charged simultaneously. In particular, during the second time period t2, the sharing switch device T3 is turned on, and the capacitor CS electrically connected with the sharing switch device T3 is charged, such that the capacitor CS has a voltage Vcs.

Herein, the voltage Vsub of the sub pixel electrode which is electrically connected to the sharing switch device T3 is dropped owing to the influence of the capacitor CS, such that the voltage Vsub of the sub pixel electrode is different from the voltage Vmain of the main pixel electrode. According to the embodiment, during the second time period t2, the voltage Vsub of the sub pixel electrode is lower than the voltage Vmain of the main pixel electrode through the influence of the capacitor CS.

According to the embodiment, the voltage Vmain of the main pixel electrode (one of the first pixel electrode PE1 and the second pixel electrode PE2) is different from the voltage Vsub of the sub pixel electrode (the other one of the first pixel electrode PE1 and the second pixel electrode PE2) during the second time period t2. Therefore, the pixel electrodes in a single pixel structure have different voltages with the driving method of the embodiment, and the display medium 2000 (shown in FIG. 20) corresponding to each of the alignment regions in the single pixel structure can be driven with different voltages so as to achieve multi-domain alignment and reduce color washout phenomenon.

In the pixel structure shown in any one of FIG. 1-FIG. 15, the first pixel electrode PE1 and the second pixel electrode PE2 have different voltages though disposing the second scan line SL2 and the sharing switch device T3, so as to reduce color washout phenomenon, and it is not limited in the present invention. According to other embodiments, the first pixel electrode PE1 and the second pixel electrode PE2 have may have different voltages with other layout designs, so as to reduce color washout phenomenon.

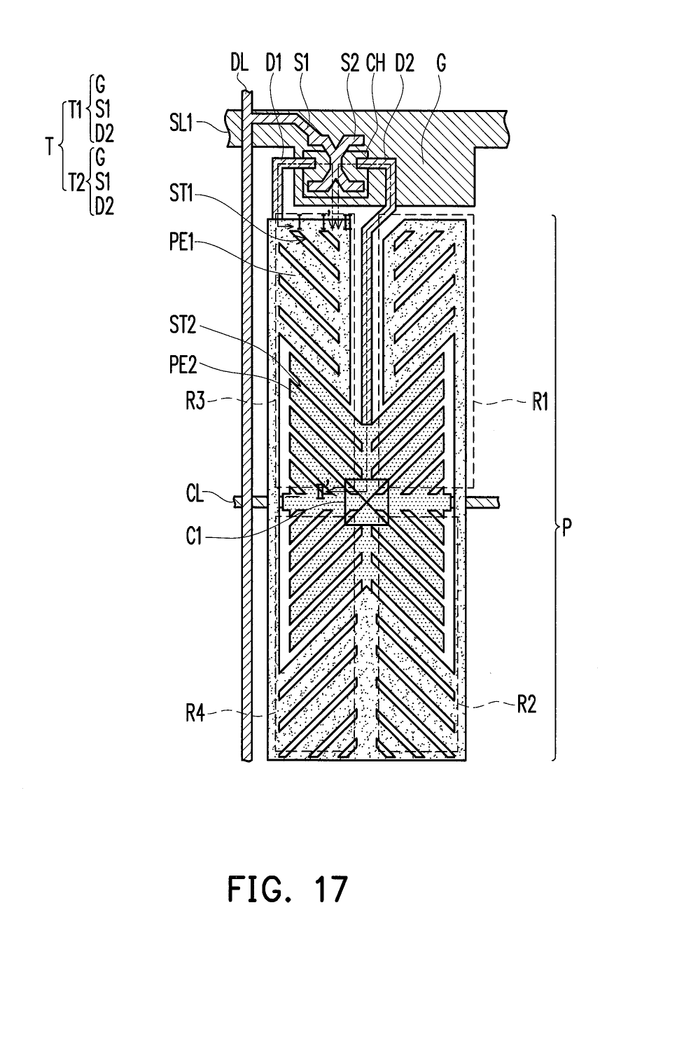

FIG. 17 is a schematic diagram showing a top view of a pixel structure according to an embodiment of the present invention. With reference to FIG. 17, the embodiment is similar to the embodiment depicted in FIG. 1, and the same components indicated in FIG. 1 and FIG. 17 are denoted by the same numerals and are not repeated herein. In the embodiment, the pixel structure comprises the first scan line SL1, the data line DL, the driving device T, the first pixel electrode PE1, the insulating layer 104 and the second pixel electrode PE2. In the embodiment, the second scan line and the sharing switch device are omitted.

According to the embodiment, the first pixel electrode PE1 and the second pixel electrode PE2 are electrically connected to the driving device T, and the first pixel electrode PE1 and the second pixel electrode PE2 are separated from each other through the insulating layer 104. Herein, the first pixel electrode PE1 is directly connected to the driving device T (the drain D1 of the first active device T1), and the second pixel electrode PE2 is electrically connected to the driving device T (the drain D2 of the second active device T2) through the contact window C1.

In addition, the first pixel electrode PE1 may partially overlap with the second pixel electrode PE2 or does not overlap with the second pixel electrode PE2. For instance, the first pixel electrode PE1 has a first area (A1), the second pixel electrode PE2 has a second area (A2), and an overlapping region between the first pixel electrode PE1 and the second pixel electrode PE2 has an overlapping area (A0), wherein A0/(A1+A2−A0)=0%-15%. Therefore, most of the first pixel electrode PE1 and the second pixel electrode PE2 do not overlap to each other, and only small parts of the first pixel electrode PE1 and the second pixel electrode PE2 overlap to each other. In an embodiment, the first pixel electrode PE1 and the second pixel electrode PE2 do not overlap to each other, and the edge of the first pixel electrode PE1 are align to the edge of the second pixel electrode PE2. In another embodiment, the first pixel electrode PE1 and the second pixel electrode PE2 do not overlap to each other, and a space is between the edge of the first pixel electrode PE1 and the edge of the second pixel electrode PE2.

In the embodiment, the first pixel electrode PE1 and the second pixel electrode PE2 have the insulating layer 104 therebetween. When a driving signal passes the driving device T to charge the first pixel electrode PE1 and the second pixel electrode PE2, the display medium disposed above the first pixel electrode PE1 and the display medium disposed above and the second pixel electrode PE2 are affected by different voltages even though the first pixel electrode PE1 and the second pixel electrode PE2 are applied with the same voltage. For example, the first pixel electrode PE1 is disposed under the insulating layer 104, and the second pixel electrode PE2 is disposed above the insulating layer 104. When the first pixel electrode PE1 and the second pixel electrode PE2 are applied with the same voltage, the voltage affecting the display medium disposed above the first pixel electrode PE1 is lower than the voltage affecting the display medium disposed above and the second pixel electrode PE2, and thus the multi-domain alignment can be achieved and the color washout phenomenon can be reduced.

In addition, the shape or the profile of the first pixel electrode PE1 and the second pixel electrode PE2 shown in FIG. 4 and FIG. 6-15 may also applied to the pixel structure of FIG. 17. Namely, in the pixel structures of FIG. 4 and FIG. 6-15, the second scan line SL2 and the sharing switch device T3 can be omitted. Herein, the voltage affecting the display medium disposed above the first pixel electrode PE1 is still different from the voltage affecting the display medium disposed above and the second pixel electrode PE2, so as to achieve multi-domain alignment and reduce color washout phenomenon.

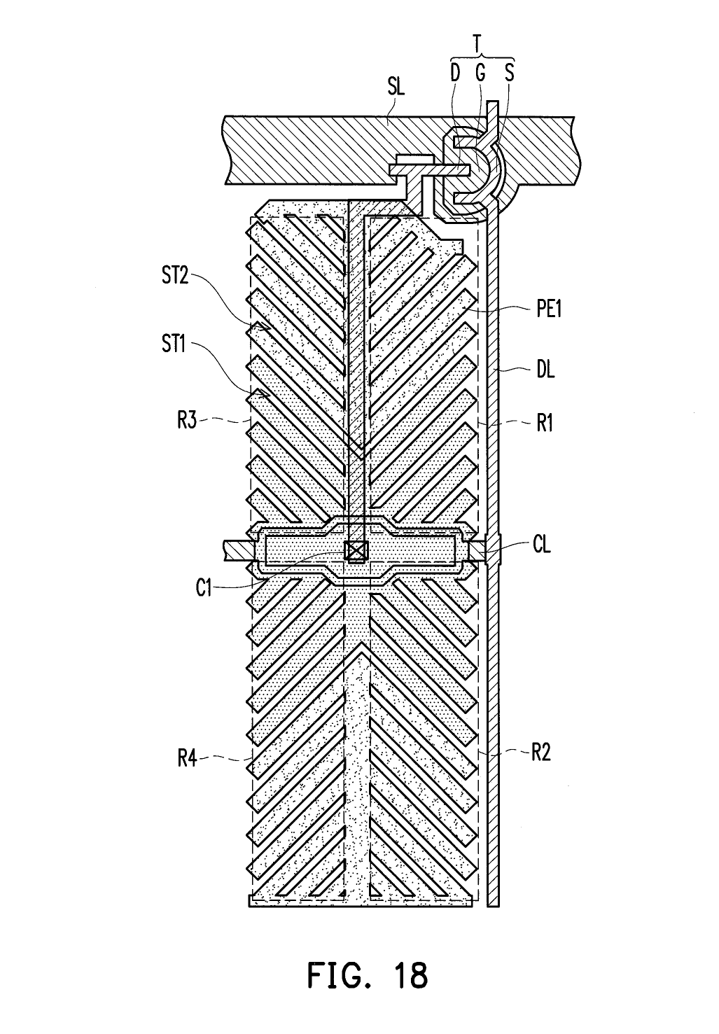

FIG. 18 is a schematic diagram showing a top view of a pixel structure according to an embodiment of the present invention. With reference to FIG. 18, the embodiment is similar to the embodiment depicted in FIG. 17, and the same components indicated in FIG. 17 and FIG. 18 are denoted by the same numerals and are not repeated herein. In the embodiment, the driving device T is a single thin film transistor which comprises a gate G, a source S and a drain D. The first pixel electrode PE1 and the second pixel electrode PE2 are electrically connected to the drain D of the driving device T. For detail, the first pixel electrode PE1 is directly connected to the drain D of the driving device T, and the second pixel electrode PE2 is electrically connected to the drain D of the driving device T through a contact window C3 in the insulating layer 104.

In the embodiment, the first pixel electrode PE1 and the second pixel electrode PE2 have the insulating layer 104 therebetween. When a driving signal passes the driving device T to charge the first pixel electrode PE1 and the second pixel electrode PE2, the display medium disposed above the first pixel electrode PE1 and the display medium disposed above and the second pixel electrode PE2 are affected by different voltages. For example, the first pixel electrode PE1 is disposed under the insulating layer 104, and the second pixel electrode PE2 is disposed above the insulating layer 104, and therefore the voltage affecting the display medium disposed above the first pixel electrode PE1 is lower than the voltage affecting the display medium disposed above and the second pixel electrode PE2. Since the voltage affecting the display medium disposed above the first pixel electrode PE1 is different from the voltage affecting the display medium disposed above and the second pixel electrode PE2, the multi-domain alignment can be achieved and the color washout phenomenon can be reduced.

In addition, the shape or the profile of the first pixel electrode PE1 and the second pixel electrode PE2 shown in FIG. 4 and FIG. 6-15 may also applied to the pixel structure of FIG. 18. Namely, in the pixel structures of FIG. 4 and FIG. 6-15, the second scan line SL2 and the sharing switch device T3 can be omitted, and the driving device T is a single thin film transistor.

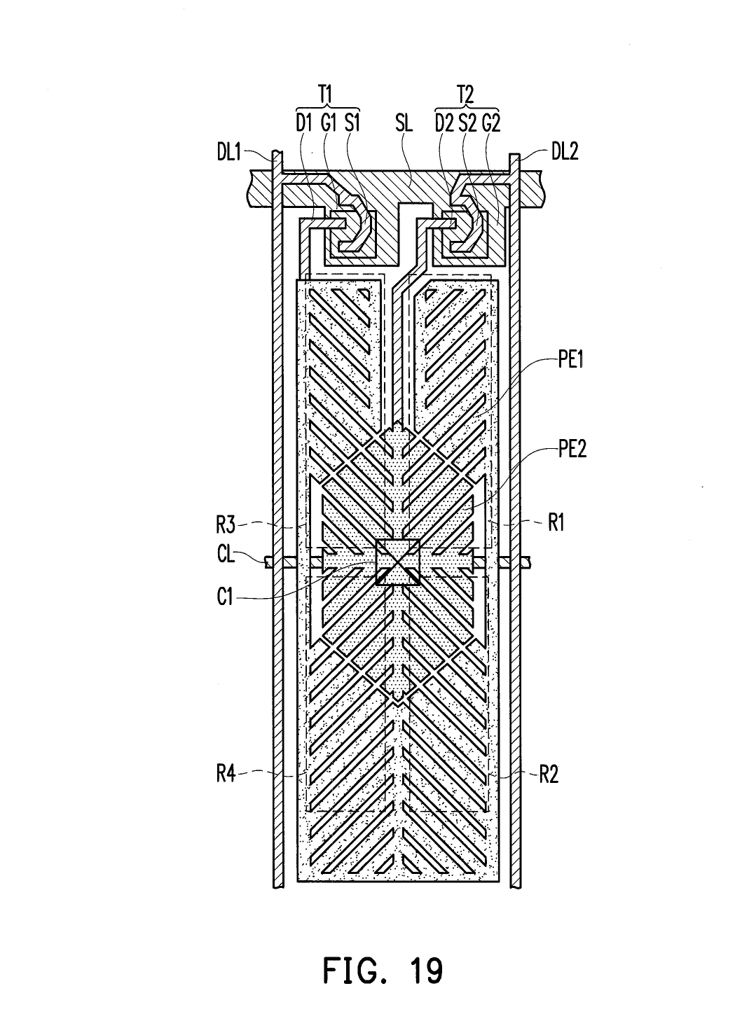

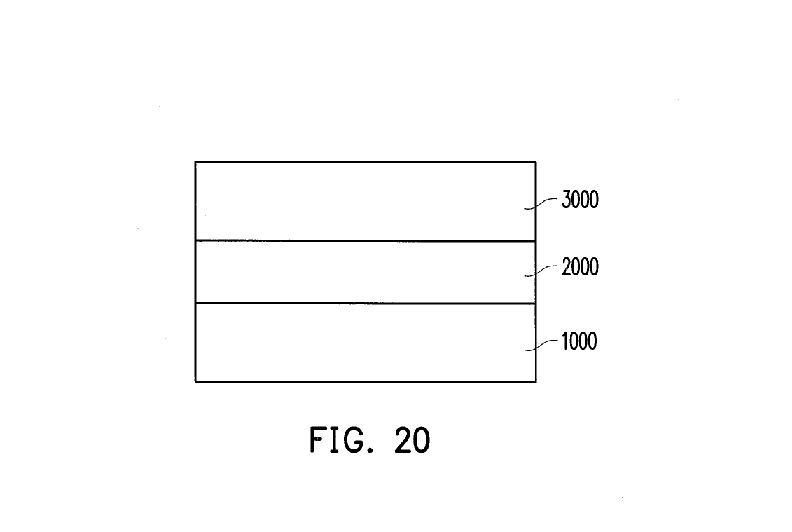

FIG. 19 is a schematic diagram showing a top view of a pixel structure according to an embodiment of the present invention. With reference to FIG. 19, the embodiment is similar to the embodiment depicted in FIG. 18, and the same components indicated in FIG. 18 and FIG. 19 are denoted by the same numerals and are not repeated herein. In the embodiment, the pixel structure comprises a first data line DL1, a second data line DL2, the first scan line SL1, the driving device T(the first active device T1 and the second active device T2), the first pixel electrode PE1, the insulating layer 104 and the second pixel electrode PE2.

The first active device T1 is electrically connected to the first data line DL1 and the first scan line SL1, and the first pixel electrode PE1 is electrically connected to the first active device T1. The second active device T2 is electrically connected to the second data line DL2 and the first scan line SL1, and the second pixel electrode PE2 is electrically connected to the second active device T2. Namely, the first pixel electrode PE1 is controlled by the first active device T1 and the second pixel electrode PE2 is controlled by the second active device T2. Therefore, the first pixel electrode PE1 and the second pixel electrode PE2 can be charged different charge quantities though the first data line DL1 and the second data line DL2, such that the first pixel electrode PE1 and the second pixel electrode PE2 have different voltages.

In the embodiment, the first pixel electrode PE1 may partially overlap with the second pixel electrode PE2 or does not overlap with the second pixel electrode PE2. For instance, the first pixel electrode PE1 has a first area (A1), the second pixel electrode PE2 has a second area (A2), and an overlapping region between the first pixel electrode PE1 and the second pixel electrode PE2 has an overlapping area (A0), wherein A0/(A1+A2−A0)=0%-15%. Therefore, most of the first pixel electrode PE1 and the second pixel electrode PE2 do not overlap to each other, and only small parts of the first pixel electrode PE1 and the second pixel electrode PE2 overlap to each other. In an embodiment, the first pixel electrode PE1 and the second pixel electrode PE2 do not overlap to each other, and the edge of the first pixel electrode PE1 are align to the edge of the second pixel electrode PE2. In another embodiment, the first pixel electrode PE1 and the second pixel electrode PE2 do not overlap to each other, and a space is between the edge of the first pixel electrode PE1 and the edge of the second pixel electrode PE2.

In addition, the shape or the profile of the first pixel electrode PE1 and the second pixel electrode PE2 shown in FIG. 4 and FIG. 6-15 may also applied to the pixel structure of FIG. 19.

In the embodiment, the first pixel electrode PE1 and the second pixel electrode PE2 are charged different charge quantities though the first data line DL1 and the second data line DL2, such that the first pixel electrode PE1 and the second pixel electrode PE2 have different voltages, and thus the color washout phenomenon is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel structure, comprising:
a first scan line and a first data line;
a driving device electrically connected to the first scan line and the first data line;
a first pixel electrode electrically connected to the driving device;
an insulating layer covering the first pixel electrode; and
a second pixel electrode disposed on the insulating layer, wherein the second pixel electrode is electrically connected to the driving device and is not directly connected to or not contacted with the first pixel electrode.

2. The pixel structure as claimed in claim 1, further comprising:
a second scan line; and
a sharing switch device electrically connected to the second scan line, wherein the sharing switch device is electrically connected to the first pixel electrode or the second pixel electrode.

3. The pixel structure as claimed in claim 2, wherein the sharing switch device is directly connected to the first pixel electrode or the second pixel electrode.

4. The pixel structure as claimed in claim 2, wherein the sharing switch device is electrically connected to the first pixel electrode or the second pixel electrode through a contact window.

5. The pixel structure as claimed in claim 2, further comprising a capacitor electrically connected to the sharing switch device.

6. The pixel structure as claimed in claim 1, wherein the first pixel electrode and the second pixel electrode are separated from each other by the insulating layer, such that the first pixel electrode is not contacted with the second pixel electrode.

7. The pixel structure as claimed in claim 1, wherein the first pixel electrode and the second pixel electrode are not overlapped.

8. The pixel structure as claimed in claim 1, wherein the driving device comprises a first active device and a second active device, the first pixel electrode is directly connected to one of the first active device and the second active device, and the second pixel electrode is electrically connected to the other one of the first active device and the second active device through a contact window.

9. The pixel structure as claimed in claim 1, further comprising a second data line, and the driving device comprises a first active device and a second active device, the first active device is electrically connected to the first scan line, the first data line and the first pixel electrode, and the second active device is electrically connected to the first scan line, the second data line and the second pixel electrode.

10. The pixel structure as claimed in claim 1, wherein the first pixel electrode is disposed at least at two sides of the second pixel electrode, or the second pixel electrode is disposed at least at two sides of the first pixel electrode.

11. The pixel structure as claimed in claim 1, wherein the first pixel electrode comprises a plurality of first slits, and the second pixel electrode comprises a plurality of second slits.

12. The pixel structure as claimed in claim 11, wherein the first scan line, the second scan line and the first data line define a pixel region, the pixel region has a plurality of alignment regions, and the first slits and the second slits in the same alignment region are parallel to each other.

13. A pixel structure, comprising:
a scan line and a data line;
a driving device electrically connected to the scan line and the data line;
a first pixel electrode having a first area (A1) and electrically connected to the driving device;
an insulating layer covering the first pixel electrode; and
a second pixel electrode having a second area (A2) and disposed on the insulating layer, the second pixel electrode being electrically connected to the driving device, wherein an overlapping region between the first pixel electrode and the second pixel electrode has an overlapping area (A0), and A0/(A1+A2−A0)=0%-15%.
